(19) United States
(12) Patent Application Publication
(10) Pub. No.: US 2006/0213447 A1
(43) Pub. Date: Sep. 28, 2006

(54) Pet feeding system to reduce consumption rate

(76) Inventors: Michael Brent Kitchen, Virginia Beach, VA (US); Jennifer Nicole Kitchen, Virginia Beach, VA (US)

Correspondence Address: Michael B. Kitchen, 4408 Monmouth Castle Rd, Virginia Beach, VA, 23455-6108, US

(21) Appl. No.: 11/087,542

(22) Filed: Mar. 23, 2005

(51) Int. Cl. A01K 5/01

(52) U.S. Cl. 119/61.5

(57) ABSTRACT

An article of manufacture to prevent dogs from bolting down dog food and dog chow with integrated obstructions, one piece design, and a bottom-biased center of gravity.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to a pet feeding system and more specifically to an article of manufacture to prevent dogs from bolting down dog food and dog chow. The use of pet feeding dishes is known in the prior art. More specifically, feeding dishes heretofore devised and utilized for use in feeding pets are known to consist basically of familiar, expected and obvious structural configurations, notwithstanding the myriad of designs encompassed by the crowded prior art which have been developed for the fulfillment of countless objectives and requirements.

U.S. Pat. No. 3,661,121 to Zielin discloses a dog feeding apparatus.

U.S. Pat. No. 6,273,027 to Watson, et al. discloses an automated training device using food.

U.S. Pat. No. 6,209,487 to Quinlan, et al. discloses an elevated pet feeding system.

While these devices fulfill their respective, particular objectives and requirements, the aforementioned patents do not disclose keeping the animal from bolting down the food.

In these respects, the pet feeding system according to the present invention substantially departs from the conventional concepts and designs of the prior art, and in so doing provides a device primarily developed for the purpose of slowing down the rate which the animal eats integral to the pet feeding dish.

Therefore, it can be appreciated that there exists a continuing need for a new pet feeding dish which employ integrated obstructions. In this regard, the present invention substantially fulfills this need.

### BRIEF SUMMARY OF THE INVENTION

The primary object of the invention is to provide a way to reduce the ability of dogs to gulp down dog food.

Another object of the invention is to reduce the risk of Gastric Dilatation-Volvulus (GDV), in dogs, more commonly know as bloat.

Another object of the invention is to provide a filling and healthy meal by slowing the dogs' intake of food.

A further object of the invention is to provide a difficult to tip container.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture to prevent dogs from bolting down dog food and dog chow; comprising: integrated obstructions, one piece design, and bottom biased center of gravity.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a top view of the invention.

FIG. 2 is a side view of the invention.

FIG. 3 is a perspective view of the invention.

FIG. 4 is a full sectional perspective view of the invention.

### DETAILED DESCRIPTION OF THE PREFERRED EMBODIMENTS

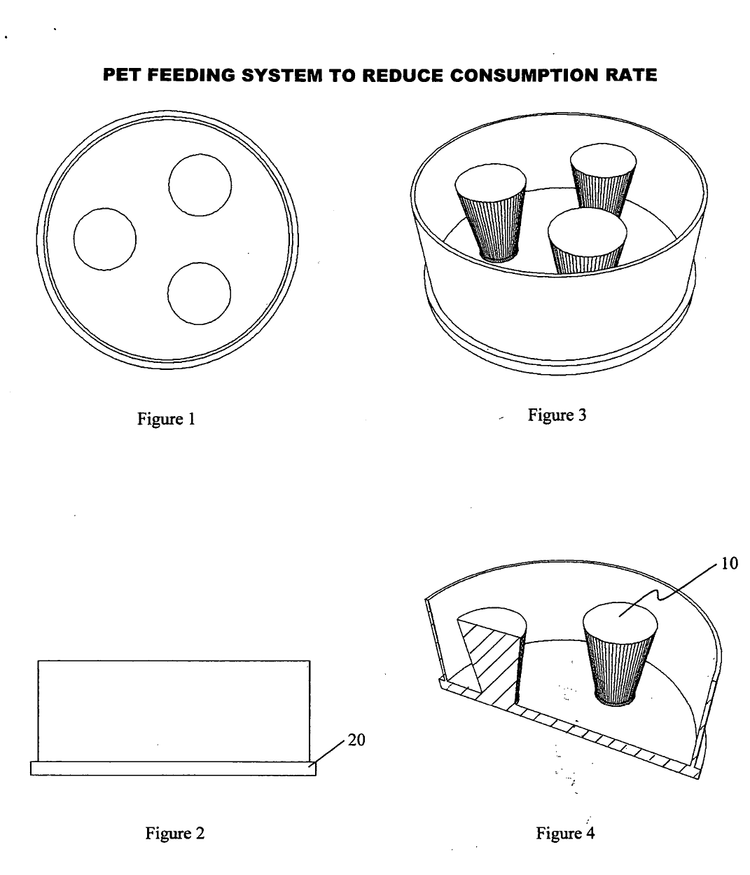

Detailed descriptions of the preferred embodiment are provided herein (FIGS. 1-4). It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. In view of the known types of dog feeding dishes now present in the prior art, the present invention provides a new dog feeding method and bowl construction wherein the bowl shape is utilized to provide the stated benefits. Thus preventing the animal from bolting down dog food and or dog chow; this provides a healthier and filling meal for the animal and helps reduce the risk of Gastric Dilatation-Volvulus (common name in dogs: bloat).

To attain this, the present invention generally comprises a new and improved dog feeding system comprising, in combination, a bowl having an inner surface, an outer surface, a bottom, integrated solid obstructions (10); and an upper periphery; and a solid circular base (20) providing a bottom biased center of gravity making the container more difficult to tip.

Any material that provides a rigid and durable final product is suitable for manufacture. In a preferred design, the feeding vessel (FIG. 3) may be made of a plastic material. Such plastics have included high density polyethylene and polypropylene. Preferred is High Density Polyethylene (HDPE). Additives may be added to the polypropylene to increase the rigid-ness of the plastic, which is known in the art as filled polypropylene. The wall thickness may be any desired thickness that when combined with the type of plastic, gives sufficient rigid-ness. Preferred in the present invention is a thickness of approximately ¼ inch. The plastic material is formed through a blow molding or preferably injection molding process to produce the individual pieces.

The invention has been described with reference to a preferred embodiment. Obviously, modifications and alterations will occur to others upon a reading and understanding of this specification. While the present invention has been illustrated with one obstruction, it should be appreciated that the feeding apparatus of the present invention may be suitably configured with one or more obstructions. Additionally, it should be appreciated that the present invention may be adapted for use by animals other than dogs. In this respect, the height and size of the pet feeding apparatus may be adapted for both smaller and larger animals. It is intended that all such modifications and alterations be included insofar as they come within the scope of the appended claims or the equivalent thereof.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture to prevent dogs from bolting down dog food and dog chow. Comprising:
Integrated obstructions;
One piece design; and
Bottom biased center of gravity.
